(19) United States
(12) Patent Application Publication
(10) Pub. No.: US 2005/0018952 A1
(43) Pub. Date: Jan. 27, 2005

(54) Optical transmitter

(75) Inventor: Kazuhiro Shimada, Fukuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/873,220

(22) Filed: Jun. 23, 2004

(30) Foreign Application Priority Data
Jun. 24, 2003 (JP) 2003-179321

(51) Int. Cl. G02B 6/26; G02B 6/42

(52) U.S. Cl. 385/16

(57) ABSTRACT

There is provided an optical transmitter capable of highly accurate temperature compensation of optical output, and producible with a lower cost. The optical transmitter includes a light-emitting element including a first diode (light-emitting diode) and second diode formed together on the same semiconductor chip. The light-emitting element is used to measure a forward voltage across the second diode, which varies correspondingly to a change of the temperature of the light-emitting and increase or decrease the drive current through the first diode correspondingly to a change of the forward voltage. Also, a light-emitting element including a first diode (light-emitting diode) and second diode formed together on the same semiconductor chip is used to keep constant the temperature of the light-emitting element itself with the utilization of the heat dissipation from the second diode.

### CROSS-REFERENCE TO RELATED APPLICATION

This application is based upon and claims the benefit of priority from prior Japanese Patent Application No. 2003-179321, filed on Jun. 24, 2003, the entire contents of which are incorporated herein by reference.

### BACKGROUND OF THE INVENTION

1. Field of the Invention

The present invention relates to an optical transmitter.

2. Background Art

As well known, the optical transmission is a technique for data transmission using light emitted from a light-emitting element, and is applied in various fields of technique. In the optical transmission, an optical transmitter converts a digital electric signal to an optical signal for transmission, receives or detects the optical signal and converts it back into a digital electric signal. The optical transmission is advantageous for being not susceptible to electromagnetic noise, and so it has been used more and more widely.

In the above optical transmitter, the light-emitting element turns on when an electric signal supplied thereto is at H level, and it turns off when the input electric signal is at L level. The optical output from the light-emitting element should desirably be constant for the reason that a variation of the optical output as large as 40% or so, for example, will make it necessary to use a high-performance optical receiver in order to assure accurate reception of the optical output. However, the optical output from the light-emitting element varies depending upon an ambient temperature Tₐ and a temperature Tⱼ of the light-emitting element that is correlated with the ambient temperature Tₐ. On this account, the optical transmitter is arranged to make temperature compensation of the light-emitting element to suppress the temperature-caused variation in optical output of the light-emitting element (cf. Japanese Patent Laid Open No. 36047/1996).

Referring now to FIG. 8, there is schematically illustrated an example of the conventional optical transmitter. As shown, the optical transmitter includes a light-emitting element 101. Many optical transmitters of this type use a surface emitting diode such as LED (light-emitting diode) as the light-emitting element. In the optical transmitter shown in FIG. 8, an electric signal for transmission is supplied to an input terminal 121 of a transmission circuit 102. The transmission circuit 102 includes an input circuit 131, drive circuit 132 and a temperature detection circuit 133. The light-emitting element 101 is connected to an output terminal 122 of the transmission circuit 102. In this example, the light-emitting element 101 is connected at the anode thereof to the output terminal 122 and at the cathode to the ground.

In the optical transmitter in FIG. 8, the light-emitting element 101 is supplied with a drive current from the output terminal 122, and emits light. As mentioned above, the optical output Pₒ varies depending upon the temperature Tⱼ of the light-emitting element 101. The higher the temperature Tⱼ, the lower the optical output Pₒ becomes. On this account, the optical transmitter shown in FIG. 8 is arranged such that the temperature detection circuit 133 detects the ambient temperature Tₐ and makes temperature compensation of the optical output from the light-emitting element 101 by increasing or decreasing the drive current through the light-emitting element 101 correspondingly to the detected ambient temperature Tₐ.

More particularly, in the transmission circuit 102 of the optical transmitter shown in FIG. 8, the temperature detection circuit 133 detects the ambient temperature Tₐ. The temperature detection circuit 133 includes a resistor having a temperature characteristic, diode, transistor, etc. The output voltage from the temperature detection circuit 133 drops when the ambient temperate Tₐ rises. The output voltage from the temperature detection circuit 133 is supplied to a control termination of the drive circuit 132. Then, when the output voltage drops, the drive circuit 132 will output a larger current. Thus, the drive current from the output terminal 122 is increased. Namely, when the ambient temperature Tₐ rises and thus the optical output from the light-emitting element 101 decreases, the drive current will be increased for compensation of the optical output. Thus, the optical output from the light-emitting element 101 is prevented from being decreased due to a temperature elevation. In the optical transmitter, there is made such a temperature compensation of the optical output.

FIG. 9 shows another example of the conventional optical transmitter. As shown, the optical transmitter includes a light-emitting element 101. Many optical transmitters of this type use an LD (laser diode) as the light-emitting element 101. The LD can operate more rapidly than the LED. Note however that the LD has the optical output thereof varied due to a temperature change more greatly than the LED, its threshold is also varied due to a temperature change and LD products greatly vary in optical output from one to another. This is the reason why many optical transmitters of this type in FIG. 9 use the LD as the light-emitting element 101. That is, the optical transmitter of the type shown in FIG. 9 is capable of more accurate temperature compensation of the optical output.

As shown in FIG. 9, the optical transmitter includes a photodiode (PD) 103 provided near he light-emitting element 101. The photodiode 103 directly detects an optical output from the light-emitting element 101, and outputs a detection current corresponding to the detected optical output. The detection current output from the photodiode 103 decreases when the optical output from the light-emitting element 101 is decreased due to a temperature elevation or the like. When the detection current decreases, the output current from the power detection circuit 137 is also decreased. The output current is supplied to a control terminal of the drive circuit 136. Then, when the output current from a power detection circuit 137 decreases, that from the drive circuit 136 increases. Hence, the drive current from the output terminal 123 will increase. Thus, when the optical output from the light-emitting element 101 is decreased due to a temperature elevation or the like, the drive current is increased for compensation of the optical output. In the optical transmitter shown in FIG. 9, more accurate temperature compensation is effected by directly detecting the optical output from the light-emitting element by means of the photodiode 103.

However, trying to improve the accuracy of temperature compensation in the conventional optical transmitter will lead to an increased number of parts, complicated structure and an increased manufacturing cost. Indeed, the optical transmitter having been described above with reference to FIG. 9 is capable of accurate temperature compensation, but it needs the photodiode 103 as an extra part which will add to the number of parts of the optical transmitter and lead to a more complicated package structure and hence to an increased cost of manufacture.

On the contrary, reduction of the number of parts in the conventional optical transmitter causes a problem that the accuracy of temperature compensation will be lower. More particularly, in the optical transmitter in FIG. 8, the temperature of the transmission circuit 102 is detected by the temperature detection circuit 133, and the drive current from the output terminal 122 is varied correspondingly to the detected temperature to control the optical output from the light-emitting element 101. In the optical transmitter in FIG. 8, however, the variation of the drive current or the like causes the temperature at the junction of the light-emitting element 101 to vary. Further, the optical output from the light-emitting element 101 is not directly detected in the optical transmitter in FIG. 8. So, the optical transmitter shown in FIG. 8 can not assure a high accuracy of the temperature compensation. Also, if an element capable of temperature adjustment such as Peltier element, for example, is newly provided to prevent the junction temperature of the light-emitting element 101 from being varied, the expensiveness of the Peltier element will add to the manufacturing cost.

### SUMMARY OF THE INVENTION

Accordingly, it is an object of the present invention to solve the aforementioned problem of the conventional techniques by providing an optical transmitter capable of accurate temperature compensation of optical output and which can be produced inexpensively.

In order to achieve the aforementioned object, there is provided according to one embodiment of the present invention an optical transmitter including: a drive current output circuit which is supplied with an input electric signal to output a drive current corresponding to the input electric signal, the drive current being controlled to increase or decrease with a control signal; a first diode which is supplied with the drive current from the drive current output circuits to emit light correspondingly to the supplied drive current; and a second diode formed along with the first diode in the same semiconductor chip and which has a temperature corresponding to the temperature of the first diode and supplies a signal corresponding to its own temperature as the control signal to the drive current output circuit.

Also, in order to achieve the aforementioned object, according to another embodiment of the present invention, there is provided an optical transmitter including: a drive current output circuit which is supplied with an input electric signal to output a first drive current corresponding to the input electric signal; a first diode which is supplied with the first drive current to emit light correspondingly to the supplied drive current; a third diode formed along with the first diode in the same semiconductor chip and which is supplied with a third drive current to emit light and heat itself, thus have a temperature corresponding to the supplied third drive current and control the temperature of the first diode with its own temperature; and a correction output circuit to detect a temperature, output the third drive current corresponding to the detected temperature and supply the current to the second diode.

Further, in order to achieve the aforementioned object, there is provided according to a still another embodiment of the present invention an optical transmitter including: a drive current output circuit which is supplied with an input electric signal to output a first drive current corresponding to the input electric signal, the first drive current being controlled to increase or decrease with a control signal; a first diode which is supplied with the first drive current from the drive current output circuits to emit light correspondingly to the supplied first drive current; and a second diode formed along with the first diode in the same semiconductor chip to have a temperature corresponding to the temperature of the first diode and supply a signal corresponding to its own temperature as the control signal to the drive current output circuit. a third diode formed along with the first and second diodes in the same semiconductor chip and which is supplied with a third drive current to emit light and heat itself, thus have a temperature corresponding to the supplied third drive current and control the temperature of the first diode with its own temperature; and a correction output circuit to detect a temperature, output the third drive current corresponding to the detected temperature and supply the current to the third diode.

### BRIEF DESCRIPTION OF THE DRAWINGS

FIG. 1 schematically illustrates the optical transmitter according to a first embodiment of the present invention.

FIG. 2 shows the relation between a temperature Tⱼ of a light-emitting element 1 and optical output Pₒ of a first diode 11 of the light-emitting element 1 in the optical transmitter according to the first embodiment of the present invention.

FIG. 3 shows the relation between a temperature Tⱼ of the light-emitting element 1 and forward voltage V_{f} at a second diode 12 of the light-emitting element 1 in the optical transmitter according to the first embodiment of the present invention.

FIG. 4 shows the relation between a forward voltage V_{f} at the second diode 12 and drive current I_{f} through the first diode 11 in the optical transmitter according to the first embodiment of the present invention.

FIG. 5 schematically illustrates the optical transmitter according to a second embodiment of the present invention.

FIG. 6 shows the relation between a temperature Tₐ detected by a temperature detector 35 and current I_{f2} from a correction output circuit in the optical transmitter according to the second embodiment of the present invention.

FIG. 7 schematically illustrates the optical transmitter according to a third embodiment of the present invention.

FIG. 8 schematically illustrates the conventional optical transmitter.

FIG. 9 schematically illustrates the other conventional optical transmitter.

### DETAILED DESCRIPTION OF THE INVENTION

Hereinafter, embodiments of the present invention will be described with reference to the accompanying drawings. Two embodiments of the present invention will be described.

### FIRST EMBODIMENT

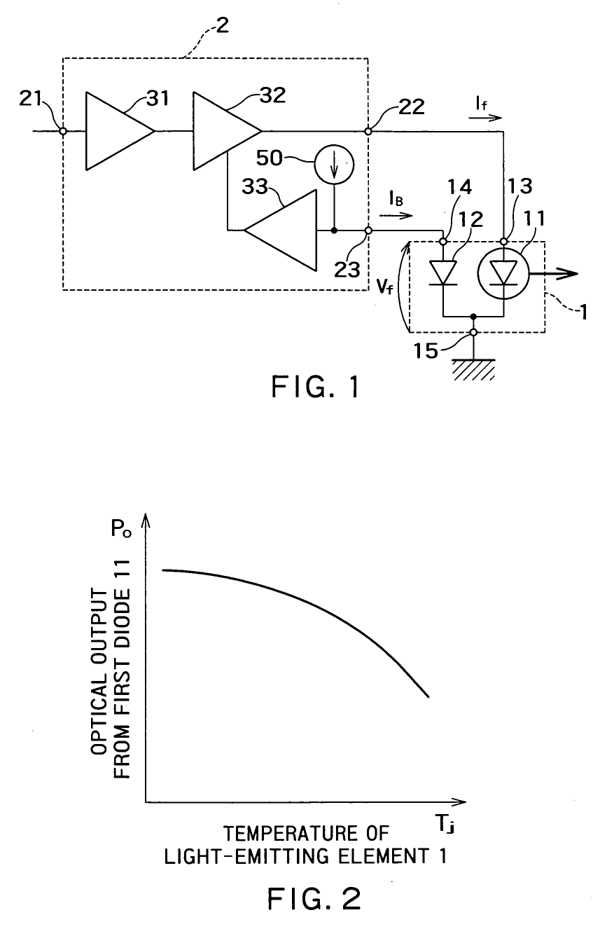

According to the first embodiment of the present invention, there is provided an optical transmitter which measures a forward voltage V_{f} at a second diode 12, varying as a light-emitting element 1 changes in temperature, and increases or decreases a drive current I_{f} through a first diode 11 as the forward voltage V_{f} varies, as shown in FIG. 1. Thus, it is possible to prevent the optical output from the first diode 11 from being varied due to a temperature change.

FIG. 1 schematically illustrates the optical transmitter according to the first embodiment of the present invention. As shown, the optical transmitter includes a light-emitting element 1 and a transmission circuit 2.

The above transmission circuit 2 includes a first input terminal 21, output terminal 22, second input terminal 23 and a constant-current circuit 50. In addition to the above, the transmission circuit 2 includes an input circuit 31, drive circuit 32 and a power detection circuit 33. The transmission circuit 2 is supplied at the first input terminal 21 thereof with a digital electric signal, and outputs, from the output terminal 22 thereof, a drive current I_{f} corresponding to the electric signal. Also, the transmission circuit 2 is supplied at the second input terminal 23 thereof with a bias current I_{B} as a constant current from the constant-current circuit 50.

The light-emitting element 1 has formed together on the same chip the first and second diodes 11 and 12, first to third external-connection terminals 13 to 15. The third terminal 15 is an external-connection electrode. The first diode 11 is connected at the anode thereof to the first external-connection terminal 13, and at the cathode to the third external-connection terminal 15. Also, the second diode 12 is connected at the anode thereof to the second external-connection terminal 14, and at the cathode to the third external-connection terminal 15. The third external-connection terminal 15 is an electrode common to the first and second diodes 11 and 12, and is connected to the ground. One of the features of the first embodiment of the present invention is that the first and second diodes 11 and 12 are formed together on the same chip. The first diode 11 is a diode such as LED and LD which emits light.

The first diode 11 is connected at the anode thereof to the output terminal 22. Supplied with the drive current I_{f} from the output terminal 22, the first diode 11 emits light. Also, the second diode 12 is connected at the anode thereof to the second input terminal 23, and supplied with the bias current I_{B} as a constant current via the second input terminal 23. The second diode 12 is driven by the bias current I_{B} as constant current, and the transmission circuit 2 measures, at the second input terminal 23, the potential at the anode of the second diode 12 to determine a potential difference (forward voltage) V_{f} between the anode and cathode of the second diode 12.

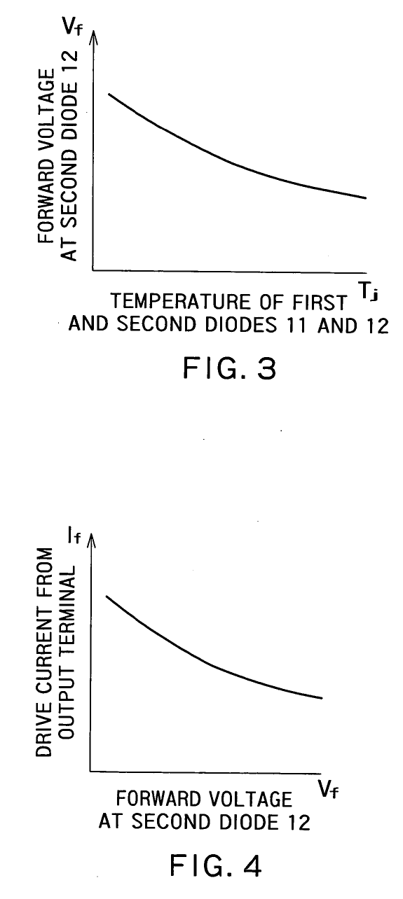

In the optical transmitter shown in FIG. 1, as the temperature Tⱼ of the light-emitting element 1 (temperature of the first and second diodes 11 and 12) increases, the optical output Pₒ from the first diode 11 decreases, as shown in FIG. 2. On this account, in the optical transmitter in FIG. 1, the temperature Tⱼ of the light-emitting element 1 is detected from the forward voltage V_{f} at the second diode 12, measured at the second input terminal 23 and the drive current I_{f} from the output terminal 22 is increased or decreased correspondingly to the detected temperature value, thereby preventing variation of the optical output Pₒ of the first diode (light-emitting diode) 11. This will be explained with reference to FIGS. 3 and 4.

FIG. 3 shows the temperature characteristic of the forward voltage V_{f} at the second diode 12. In FIG. 3, the abscissa denotes the temperature Tⱼ of the second and first diodes 12 and 11, while the ordinate denotes the forward voltage V_{f} at the second diode 12. As shown in FIG. 1, the bias current I_{B} as a constant current is supplied to the second diode 12 from the constant-current circuit 50 to provide the forward voltage V_{f}. As the diode 12 is driven by the constant current to have the temperature Tⱼ thereof elevated, as shown in FIG. 3, the forward voltage V_{f} drops. Reversely, as the diode 12 has the temperature Tⱼ thereof made to fall, it will have the forward voltage V_{f} made to up.

FIG. 4 shows the relation between the forward voltage V_{f} at the second diode 12 and drive current I_{f} through the first diode 11. In the optical transmitter shown in FIG. 1, the transmission circuit 2 is supplied at the second terminal 23 thereof with the forward voltage V_{f}. As the forward voltage V_{f} drops, the output current output from the power detection circuit 33 in the transmission circuit 2 decreases. The output current from the power detection circuit 33 is supplied to a control terminal of the drive circuit 32. As the output current from the power detection circuit 33 decreases, the output current from the drive circuit 32 increases. Thus, the drive current I_{f} from the output terminal 22 increases. As the forward voltage V_{f} at the second diode 12 drops, the drive current I_{f} increases as shown in FIG. 4, Reversely, as the forward voltage V_{f} at the second diode 12 rises, the drive current I_{f} decreases.

As seen from FIGS. 3 and 4, as the temperature Tⱼ of the light-emitting element 1 rises, the forward voltage V_{f} at the second diode 12 drops as shown in FIG. 3, and the drive current I_{f} increases correspondingly to the rate of the voltage drop as shown in FIG. 4. Thus, it is possible to prevent the optical output Pₒ from the first diode 11 from being decreased due to the elevation of the temperature Tⱼ as shown in FIG. 2. As will be seen from FIGS. 3 and 4, as the temperature Tⱼ of the light-emitting element 1 falls, the forward voltage V_{f} at the second diode 12 rises as shown in FIG. 3, and the drive current I_{f} decreases correspondingly to the rate of forward voltage rise as shown in FIG. 4. Thus, it is possible to prevent the optical output Pₒ from the first diode 11 from being increased due to the fall of the temperature Tⱼ as shown in FIG. 2. Therefore, in the optical transmitter in FIG. 1, even if the temperature Tⱼ of the light-emitting element 1 changes, it is possible to prevent variation of the optical output Pₒ from the first diode 11 in the light-emitting element 1.

Also, in the optical transmitter in FIG. 1, the temperature Tⱼ of the light-emitting element 1 is detected directly, whereby the temperature can be compensated with a higher accuracy.

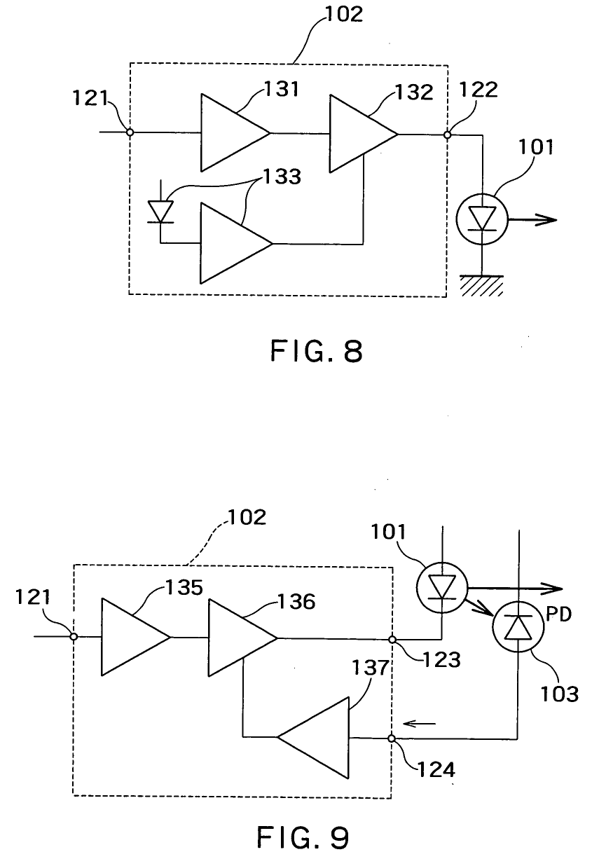

The optical transmitter in FIG. 1 does not include the photodiode 103 which is provided in the conventional optical transmitter shown in FIG. 8. So, the number of parts is less than in the conventional optical transmitter, which leads to a simpler package structure and a reduced manufacturing cost.

Also, in the optical transmitter shown in FIG. 1, reading the forward voltage V_{f} is not any load to the output terminal 22 of the transmission circuit 2, which enables a higher-speed operation of the apparatus. Thus, the optical transmitter shown in FIG. 1 can make a higher-speed optical transmission with the use of an LD (laser diode) as the first diode 11.

As above, the optical transmitter in FIG. 1 can operate at a high speed with a higher accuracy of the temperature compensation of the optical output and can be produced with a less manufacturing cost.

In the optical transmitter having been described above with reference to FIG. 1, the anode and cathode of the first and second diodes 11 and 12 may be connected reversely.

Also, the second diode 12 in the optical transmitter shown in FIG. 1 should preferably be a diode which does not emit light for the purpose of accurate temperature detection. Note however that the second diode 12 may be a diode which emits extremely weak light, for example, less than 1/10 of the light emitted from the first diode 11.

### SECOND EMBODIMENT

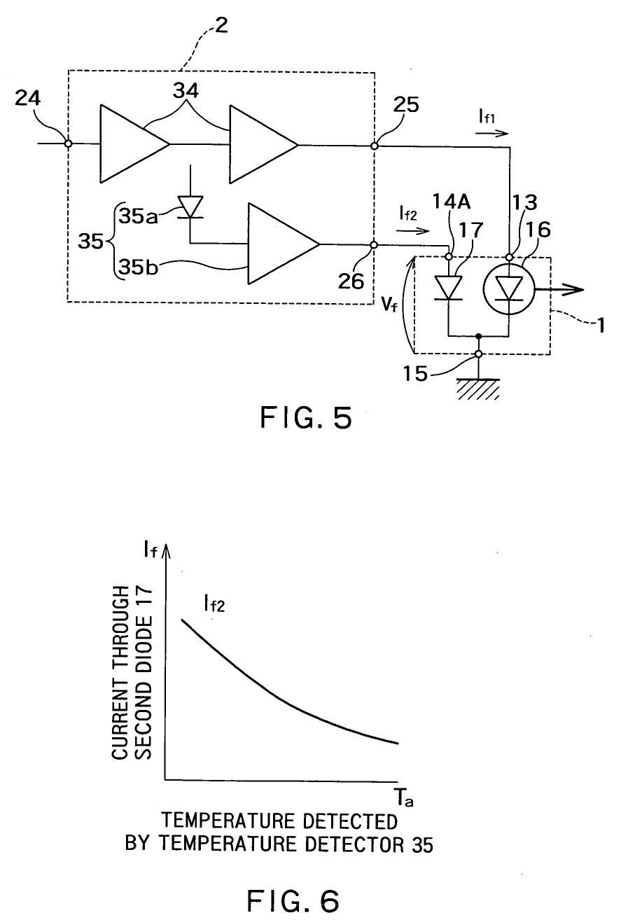

Next, the second embodiment of the present invention will be described. The optical transmitter as the second embodiment uses a second diode 17 as shown in FIG. 5 to maintain the light-emitting element 1 at a constant temperature. With this feature, it is possible to make temperature compensation of the optical output from a first diode 16 in the light-emitting element 1 with an improved accuracy.

FIG. 5 shows the optical transmitter according to the second embodiment of the present invention. As shown, the optical transmitter includes an input circuit/drive circuit 34, input terminal 24, first output terminal 25, light-emitting element 1, and a correction output circuit (26 and 35). The transmission circuit 2 includes an input terminal 24 and first output terminal 25, and outputs, from the first output terminal 25, a drive current I_{f1} corresponding to an input electric signal supplied to the first input terminal 24. Also, the transmission circuit 2 incorporates the correction output circuit (26 and 35). The correction output circuit includes a temperature detector 35 and second output terminal 26. The temperature detector 35 detects a temperature, and outputs, from the second output terminal 26, a current I_{f2} corresponding to the detected temperature. More specifically, the temperature detector 35 includes an element such as a resistor having a temperature characteristic, diode, transistor, etc., and an amplifier 35b, and outputs a voltage which varies with a temperature. The current I_{f2} decreases when the temperature detector 35 detects a higher temperature (ambient temperature) Tₐ, while increasing when the detected temperature Tₐ is lower.

The light-emitting element 1 has formed together on the same chip the first and second diodes 16 and 17, first to third external-connection terminals 13, 14A and 15. The third terminal 15 is an external-connection electrode. The first diode 16 is connected at the anode thereof to the first external-connection terminal 13, and at the cathode to the third external-connection terminal 15. Also, the second diode 17 is connected at the anode thereof to the second external-connection terminal 14A, and at the cathode to the third external-connection terminal 15. The third external-connection terminal 15 is an electrode common to the first and second diodes 16 and 17, and is connected to the ground.

The first diode 16 is a diode such as LED and LD which emit light. The second diode 17 is a diode which does not emit light. One of the features of the optical transmitter shown in FIG. 5 is that the second diode 17 can adjust the temperature of the light-emitting element 1.

In the optical transmitter in FIG. 5, the first external-connection terminal 13 is connected to the first output terminal 25 so that the first diode 16 is driven by the drive current I_{f1} from the first output terminal 25 to emit light. Also, the second external-connection terminal 14A is connected to the second output terminal 26 so that the second diode 17 is driven by the current I_{f2} from the second output terminal 26.

In the optical transmitter in FIG. 5, when the temperature detector 35 detects a higher temperature Tₐ, the current I_{f2} decreases correspondingly to the rate of temperature elevation as shown in FIG. 6. Thus, the temperature of the second diode 17 falls and the temperature Tⱼ of the light-emitting element 1 is prevented from being elevated. That is, as the temperature Tₐ rises, the current I_{f2} through the second diode 17 decreases correspondingly to the rate of temperature elevation, and the temperature Tⱼ of the light-emitting element 1 is prevented from being elevated. Thus, the temperature of the light-emitting element 1 can be kept constant. Also, as the temperature Tₐ falls, the current I_{f2} through the second diode 17 increases correspondingly to the rate of temperature fall, and the temperature Tⱼ of the light-emitting element 1 is prevented from falling. Thus, the temperature Tⱼ of the light-emitting element 1 is kept constant, and thus the optical output Pₒ from the first diode in the light-emitting element 1 can be kept constant.

In the optical transmitter having been described above with reference to FIG. 5, since the temperature at the junction of the light-emitting element 1 varies little, it is possible to make temperature compensation of the optical output Pₒ from the first diode 16 (light-emitting diode) with a higher accuracy.

Also, the optical transmitter in FIG. 5 does not include any extra photodiode. So, the number of parts becomes small, which leads to a simpler package structure, a reduced number of structural elements and a reduced manufacturing cost.

In the optical transmitter shown in FIG. 5, although the light-emitting element 1 is maintained at a high temperature Tⱼ, there occurs no large variation in the drive current I_{f1} through the first diode 16 in the light-emitting element 1 as well as in the temperature at the junction of the light-emitting element 1. Thus, the first diode 16 has a longer service life, resulting in a longer life of the light-emitting element 1 in the optical transmitter shown in FIG. 5.

As having been described in the foregoing, the present invention can provide a low cost optical transmitter (as shown in FIG. 5) in which temperature compensation of the optical output can be done with a high accuracy. Also, the optical transmitter in FIG. 5 is advantageously usable especially in case the service life of the light-emitting element 1 may greatly be varied by an increase of the drive current I_{f1}.

In the optical transmitter having been described above with reference to FIG. 5, the anode and cathode of the second and first diodes 17 and 16 may be connected reversely. Also, the temperature detector 35 in the transmission circuit 2 can be made to control the drive current I_{f1} as well as the current I_{f2}.

### THIRD EMBODIMENT

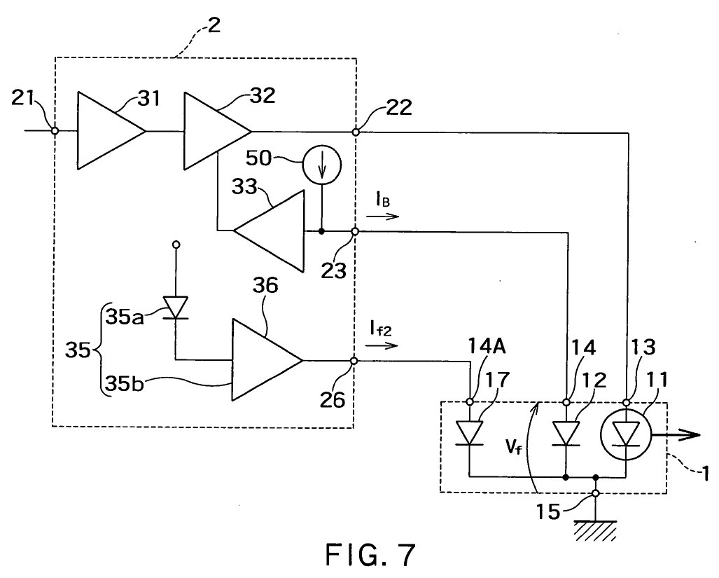

FIG. 7 schematically illustrates the optical transmitter according to a third embodiment of the present invention. In the third embodiment, the optical transmitters according to FIGS. 1 and 5 are combined to formulate an optical transmitter and thus three diodes are used. In FIG. 7, same reference numerals are added to the elements equivalent to that of FIGS. 1 and 5.

According to the present invention, there can be provided the optical transmitter in which the light-emitting element including the first diode which emits light and second diode formed together on the same chip is used to measure a forward voltage at the second diode, the forward voltage varying depending upon a variation in temperature of the light-emitting element. The drive current through the first diode is controlled to increase or decrease correspondingly to a change of the forward voltage. Therefore, according to the present invention, the low cost optical transmitter with temperature compensation of the optical output with a high accuracy is provided. Also, the temperature of the light-emitting element including the first diode which emits light and second diode formed together on the same chip is kept constant by use of a heat of the second diode. Therefore, the present invention provides the low cost optical transmitter capable of highly accurate temperature compensation of the optical output.

1. An optical transmitter comprising:
a drive current output circuit which is supplied with an input electric signal to output a drive current corresponding to the input electric signal, the drive current being controlled to increase or decrease with a control signal;
a first diode which is supplied with the drive current from the drive current output circuits to emit light correspondingly to the supplied drive current; and
a second diode formed along with the first diode on the same semiconductor chip to have a temperature corresponding to the temperature of the first diode and supply a signal corresponding to its own temperature as the control signal to the drive current output circuit.

2. The optical transmitter according to claim 1, wherein the second diode is a diode to emit no light or a diode to emit light which is weaker than that emitted by the first diode.

3. The optical transmitter according to claim 2, wherein the second diode emits light whose intensity is less than 1/10 of that emitted by the first diode.

4. The optical transmitter according to claim 1, wherein with the second diode being supplied with a current, the control signal is generated on the basis of a voltage resulted from a drop of a voltage across the second diode, which varies correspondingly to the temperature of the second diode.

5. The optical transmitter according to claim 4, wherein the second diode is supplied with a constant current as a second drive current.

6. The optical transmitter according to claim 4, wherein the first diode is connected between an output terminal of the drive current output circuit and a power terminal, and the second diode is connected between a current source and a power terminal.

7. The optical transmitter according to claim 1, further comprising a power detection circuit applied with the voltage resulted from the drop of the voltage across the second diode as a voltage signal to output the control signal corresponding to the voltage signal.

8. An optical transmitter comprising:
a drive current output circuit which is supplied with an input electric signal to output a first drive current corresponding to the input electric signal;
a first diode which is supplied with the first drive current to emit light correspondingly to the supplied drive current;
a third diode formed along with the first diode on the same semiconductor chip and which is supplied with a third drive current to emit light and heat itself, thus have a temperature corresponding to the supplied third drive current and control the temperature of the first diode with its own temperature; and
a correction output circuit to detect a temperature, output the third drive current corresponding to the detected temperature and supply the current to the second diode.

9. The optical transmitter according to claim 8, wherein the third diode is a diode to emit no light.

10. The optical transmitter according to claim 8, wherein the first diode is connected between an output terminal of the drive current output circuit and a power terminal, and the third diode is connected between the correction output circuit and a power terminal.

11. The optical transmitter according to claim 8, wherein the correction output circuit includes:
a temperature detecting element to detect a temperature and output a temperature signal corresponding to the detected temperature; and
a drive circuit which is supplied with the temperature signal to output the second drive current corresponding to the input temperature signal.

12. The optical transmitter according to claim 11, wherein:
the temperature detecting element is a diode connected at one end thereof to a power terminal and at the other end to the drive circuit to output a temperature control signal corresponding to a temperature to the drive circuit; and
the drive circuit is an amplifier which outputs the second drive current corresponding to the temperature control signal.

13. An optical transmitter comprising:
a drive current output circuit which is supplied with an input electric signal to output a first drive current corresponding to the input electric signal, the first drive current being controlled to increase or decrease with a control signal;
a first diode which is supplied with the first drive current from the drive current output circuits to emit light correspondingly to the supplied first drive current; and
a second diode formed along with the first diode on the same semiconductor chip to have a temperature corresponding to the temperature of the first diode and supply a signal corresponding to its own temperature as the control signal to the drive current output circuit.
a third diode formed along with the first and second diodes on the same semiconductor chip and which is supplied with a third drive current to emit light and heat itself, thus have a temperature corresponding to the supplied third drive current and control the temperature of the first diode with its own temperature; and
a correction output circuit to detect a temperature, output the third drive current corresponding to the detected temperature and supply the current to the third diode.

14. The optical transmitter according to claim 13, wherein the second diode is a diode to emit no light or a diode to emit light which is weaker than that emitted by the first diode.

15. The optical transmitter according to claim 14, wherein the second diode emits light whose intensity is less than 1/10 of that emitted by the first diode.

16. The optical transmitter according to claim 13, wherein with the second diode being supplied with a current, the control signal is generated on the basis of a voltage resulted from a drop of a voltage across the second diode, which varies correspondingly to the temperature of the second diode.

17. The optical transmitter according to claim 16, wherein the second diode is supplied with a constant current as a second drive current.

18. The optical transmitter according to claim 16, wherein the first diode is connected between an output terminal of the drive current output circuit and a power terminal, the second diode is connected between a current source and a power terminal, and the third diode is connected between the correction output circuit and a power terminal.

19. The optical transmitter according to claim 13, further comprising a power detection circuit applied with the voltage resulted from the drop of the voltage across the second diode as a voltage signal to output the control signal corresponding to the voltage signal.

20. The optical transmitter according to claim 19, wherein the third diode is a diode to emit no light.

21. The optical transmitter according to claim 19, wherein the correction output circuit includes:
a temperature detecting element to detect a temperature and output a temperature signal corresponding to the detected temperature; and
a drive circuit which is supplied with the temperature signal to output the second drive current corresponding to the input temperature signal.

22. The optical transmitter according to claim 21, wherein:
the temperature detecting element is a diode connected at one end thereof to a power terminal and at the other end to the drive circuit to output a temperature control signal corresponding to a temperature to the drive circuit; and
the drive circuit is an amplifier which outputs the second drive current corresponding to the temperature control signal.
